(19) United States
(12) Patent Application Publication
(10) Pub. No.: US 2009/0108244 A1
(43) Pub. Date: Apr. 30, 2009

(54) Motorcycle lifting device

(76) Inventor: Dwight Reidling, Toledo, OH (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 11/981,257

(22) Filed: Oct. 31, 2007

(51) Int. Cl. B66F 15/00

(52) U.S. Cl. 254/131

(57) ABSTRACT

This invention is an improved lifting device for safely assisting in the lifting of a motorcycle that has fallen onto its side. The device utilizes lever action to assist a person in lifting a motorcycle back up to its normal upright position. The device is portable, is simple to assemble and is designed to minimize the risk of injury to the user or damage to the motorcycle.

### BACKGROUND OF THE INVENTION

This invention is an improved lifting device for safely assisting in the lifting of a motorcycle that has fallen onto its side. This device utilizes lever action to assist a person in lifting a motorcycle back up to its normal upright position. In one configuration of the device, the lifting device is designed to telescope together to provide a portable device capable of being stored on a motorcycle, for instance in saddlebags.

Many motorcycles weigh several hundred pounds and are not able to be lifted to an upright position by one person without risking injury to the person or damage to the motorcycle. Lifting a fallen motorcycle in the past has been accomplished either by several people, or by using complicated non-portable lifting mechanisms. In addition to not being portable, existing lifting mechanisms are not practical to use on uneven surfaces, and are multi-part devices that require assembly. This invention is completely portable, requires little assembly, and gives one person the ability to lift a motorcycle into an upright position while minimizing the risk of injury to the person or damage to the motorcycle.

### BRIEF DESCRIPTION OF THE DRAWINGS

FIG. 1 shows the lifting device with telescopic handle extended.

FIG. 2 shows the lifting device in use attached to a fallen motorcycle.

FIG. 2a is a detailed representation of the lifting device engaged with the foot rest of a motorcycle.

FIG. 3 shows an alternative embodiment of the lifting device of the present invention.

FIG. 3A is a detailed representation of the alternative embodiment of the lifting device engaged with the foot rest of a motorcycle.

### DETAILED DESCRIPTION OF THE PREFERRED EMBODIMENT(S)

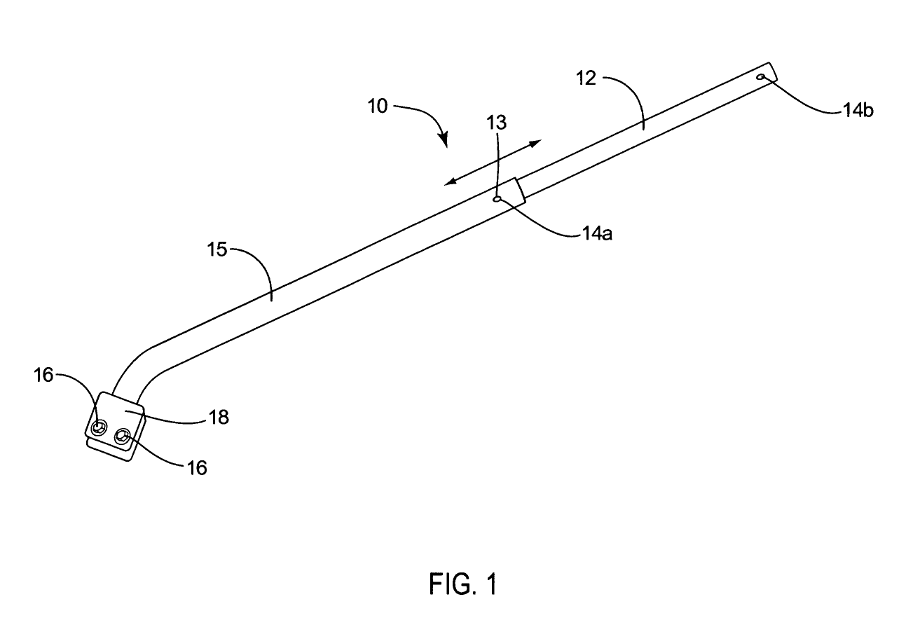

FIG. 1 shows the motorcycle lifting device with the telescopic handle in its extended position. The lifting device 10 is composed of a handle 15 of a hollow tubular cross-section. The cross-section of handle 15 is preferably circular but it could be square, etc. The handle extension 12 has an exterior diameter that is slightly smaller than the tubular inner circumference of the handle 15. The handle extension includes two spring loaded ball locking devices 14a, 14b, each locking device being spaced from its respective end of the handle extension 12. When the handle extension 12 is fully extended from the handle 15, locking ball 14a engages hole 13 located in the handle 15, thus retaining the handle extension 12 in place. When the handle extension 12 is fully telescoped into the handle 15, locking ball 14b of engages hole 13, thereby retaining the handle extension 12 in place. The opposed end of handle 15 is an open clamping channel 18 having at least two clamping bolts 16. The clamping channel 18 is designed to slide over a motorcycle foot peg and be secured to the foot peg by the tightening of the two clamping bolts 16.

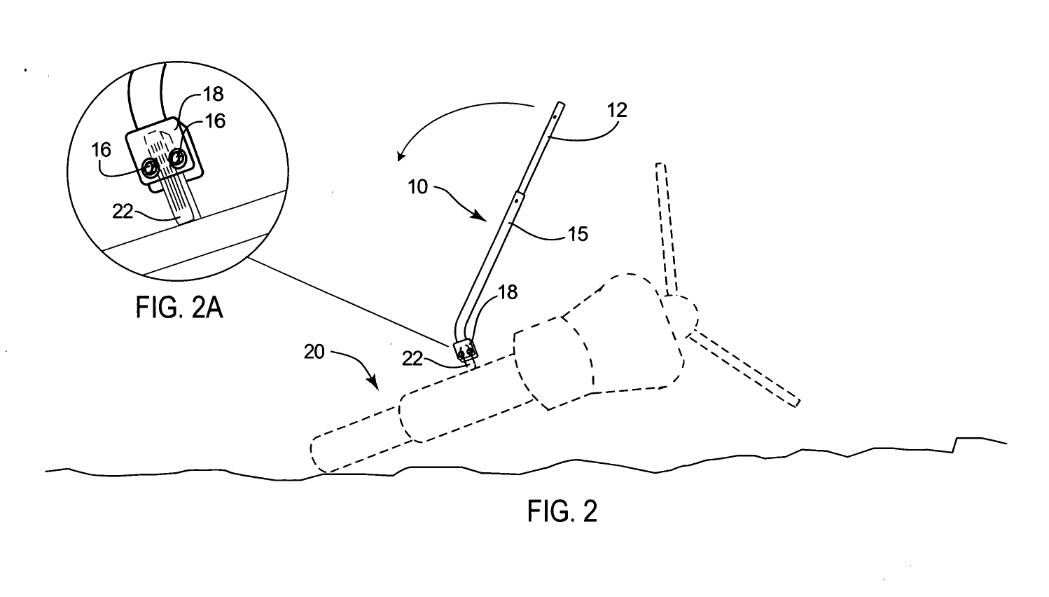

Referring now to FIGS. 2 and 2a, the motorcycle 20 is shown on the ground or pavement in a fallen position. The lifting device 10 is clamped over the motorcycle's foot peg 22 and secured to the foot peg by the clamping bolts 16. After the lifting device 10 is secured to the motorcycle, the person uprighting the cycle has the advantage of leverage provided by the device to make the lifting easier to accomplish with less risk or injury or damage. With the lifting device attached to the motorcycle, the user can pull the extended handle 12 in a downward direction (as indicated in the drawing by the arrow) to lift the motorcycle 20 back to its upright position.

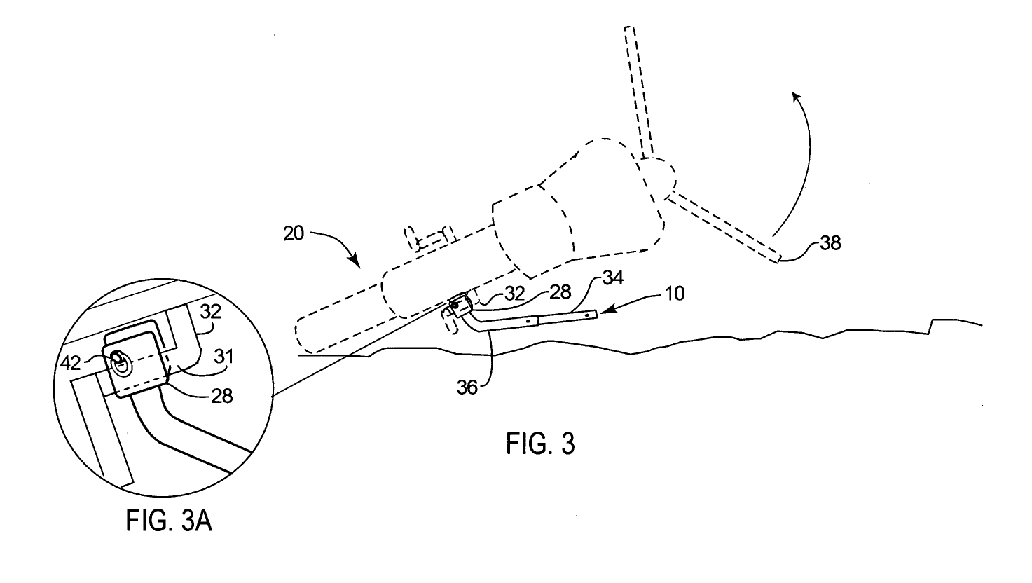

FIGS. 3 and 3A show an alternative embodiment of the lifting tool device of this invention. In FIG. 3 the motorcycle 20 is shown in a fallen position. The lifting device 10 is clamped to the foot rest post 31 of the motorcycle 20 with the back of the clamping channel 28 in a parallel position to the downward post 31 of the foot rest 32. A single locking pin 42 holds the lifting device 10 in place. With the lifting device 10 in position proximate to the ground, the user grasps the handlebar 38 of the motorcycle 20 with one hand and the extension handle 34 of the lifting device 10 with the other hand and lifts the motorcycle 20 into an upright position. The embodiment of the device allows it to be used on motorcycles with full footrests instead of foot pegs. In addition, in this configuration the user has additional leverage due to the fact that both the lifting device and handle bar may be used for lifting.

This description of the preferred embodiment is intended to be illustrative in and is not intended to be limiting upon the scope and contest of the following claims.

I claim:

1. A portable motorcycle lifting device designed to engage with the foot peg of the motorcycle and provides a lever to lift the motorcycle from a down position to an upright position comprising, in combination:
a. a handle of tubular cross-section defining an interior cavity, the handle being curved at one end and including a clamping device on the curved portion designed to engage with the foot peg of the motorcycle and
b. a handle extension defining an exterior surface designed to fit within the tubular cavity of the handle, wherein the handle extension can be retracted into the handle when not in use and extended out of the handle, thereby extending the length of the handle, when in use, wherein attachment of the clamping device to the foot peg provides for the handle and handle extension to extend upward and outward away from the motorcycle to allow for leverage to be applied to lift the motorcycle from a down position to an upright position.

2. The lifting device of claim 1 further including a locking device for retaining the handle extension in the extended position.

3. The lifting device of claim 2 further including a second locking device for retaining the handle extension in the retracted position.
